(19) United States
(12) Patent Application Publication
(10) Pub. No.: US 2012/0300776 A1
(43) Pub. Date: Nov. 29, 2012

(54) METHOD FOR CREATING VIRTUAL LINK, COMMUNICATION NETWORK ELEMENT, AND ETHERNET NETWORK SYSTEM

(75) Inventors: Lifeng LIU, Beijing (CN); Yuchen WANG, Beijing (CN); Jian MENG, Beijing (CN); Ke LI, Chengdu (CN)

(73) Assignee: HUAWEI TECHNOLOGIES CO., LTD., Shenzhen (CN)

(21) Appl. No.: 13/572,222

(22) Filed: Aug. 10, 2012

Related U.S. Application Data
(63) Continuation of application No. PCT/CN2011/070891, filed on Feb. 9, 2011.

(30) Foreign Application Priority Data
Feb. 10, 2010 (CN) 201010111255.7

(51) Int. Cl. H04L 12/56

(52) U.S. Cl. 370/390; 370/409

(57) ABSTRACT

Embodiments of the present invention provide a method for creating a virtual link, a communication network element, and an Ethernet network system. The method includes the following: a first communication network element receives a communication request message sent by a second communication network element; the first communication network element allocates a first virtual MAC address and a second virtual MAC address for the virtual link between the first communication network element and the second communication network element; the first communication network element sends a response message in response to the communication request message to the second communication network element, where the response message carries the first virtual MAC address and the second virtual MAC address. Using the technical solutions provided in the embodiments of the present invention, two communication network elements on the Ethernet are capable of performing communication using a fibre channel on the Ethernet.

### CROSS-REFERENCE TO RELATED APPLICATIONS

This application is a continuation of International Application No. PCT/CN2011/070891, filed on Feb. 9, 2011, which claims priority to Chinese Patent Application No. 201010111255.7, filed on Feb. 10, 2010, both of which are hereby incorporated by reference in their entireties.

### FIELD OF THE INVENTION

The present invention relates to a communications technology field, and in particular, to a method of creating a virtual link, a communication network element, and a communication network.

### BACKGROUND OF THE INVENTION

A fibre channel over Ethernet (Fibre Channel over Ethernet, FCoE) uses enhanced Ethernet as architecture for physical network transmission and is capable of providing standard fibre channel frame content, which avoids a Transmission Control Protocol/Internet Protocol (Transmission Control Protocol/Internet Protocol, TCP/IP) overhead. In addition, the FCoE is capable of servicing an upper-level software layer like a standard fibre channel.

The FCoE protocol is a network protocol specifically designed for a layer-2 data center network. This protocol defines a pattern of communication performed by a source communication network element and a target communication network element when the source communication network element is located on an Ethernet and the target communication network element is located on a fibre network. Specifically, the source communication network element sends a registration request message to a gateway device. The gateway device allocates a virtual media access control (Media Access Control, MAC) address to the source communication network element and sends a registration acceptance message carrying the virtual MAC address to the source communication network element. After generating a fibre channel (Fibre Channel, FC) frame, FC frame for short, the source communication network element uses the virtual MAC address as a source MAC address and an Ethernet MAC address of the gateway device as a target MAC address, encapsulates the FC frame into an Ethernet frame, and transmits the Ethernet frame. The gateway device resolves the Ethernet frame to obtain the FC frame, determines, using a destination ID in the FC frame, a target communication network element that should receive the FC frame, and sends the FC frame to the target communication network element.

The existing FCoE protocol defines a pattern of communication performed by a source communication network element and a target communication network element when the source communication network element is located on the Ethernet and the target communication network element is located on the fibre network, without defining how to use the fibre channel over Ethernet to perform communication when both communication network elements are located on the Ethernet.

### SUMMARY OF THE INVENTION

Embodiments of the present invention provide a method for creating a virtual link, a communication network element, and a communication network so that two communication network elements on an Ethernet are capable of performing communication using a fibre channel over Ethernet.

As such, the embodiments of the present invention provide:

A method for creating a virtual link, including:

receiving, by a first communication network element, a communication request message sent by a second communication network element;

allocating, by the first communication network element, a first virtual MAC address and a second virtual MAC address for a virtual link between the first communication network element and the second communication network element, where the first virtual MAC address is a virtual MAC address that identifies, in the virtual link, the first communication network element, and the second virtual MAC address is a virtual MAC address that identifies, in the virtual link, the second communication network element; and

sending, by the first communication network element, a response message in response to the communication request message to the second communication network element, where the response message carries the first virtual MAC address and the second virtual MAC address, and the first communication network element and the second communication network element are located on an Ethernet.

A communication network element that is located on an Ethernet, including:

a receiving unit, configured to receive a communication request message sent by a peer communication network element;

an address allocation unit, configured to allocate a first virtual MAC address and a second virtual MAC address for a virtual link between the communication network element and the peer communication network element after the communication request message is received, where the first virtual MAC address is a virtual MAC address that identifies, in the virtual link, the communication network element, and the second virtual MAC address is a virtual MAC address that identifies, in the virtual link, the peer communication network element; and

a sending unit, configured to send a response message in response to the communication request message to the peer communication network element, where the response message carries the first virtual MAC address and the second virtual MAC address.

In the embodiments of the present invention, the first communication network element allocates the first virtual MAC address that identifies, in the virtual link, an address of the first communication network element and the second virtual MAC address that identifies, in the virtual link, an address of the second communication network element, and notifies the second communication network element of the first virtual MAC address and the second virtual MAC address so that the first communication network element and the second communication network element that are located on the Ethernet are capable of using the virtual link identified by the first virtual MAC address and the second virtual MAC address to perform communication.

### BRIEF DESCRIPTION OF THE DRAWINGS

To describe the technical solutions in embodiments of the present invention more clearly, the accompanying drawings for describing the embodiments are described briefly in the following part. Apparently, the accompanying drawings described below are only some embodiments of the present invention and those skilled in the art my also derive other drawings from these accompanying drawings without any creative effort.

FIG. 1 is a flowchart of a method for creating a virtual link according to an embodiment of the present invention;

FIG. 2 is a flowchart of a method for creating a virtual link according to another embodiment of the present invention;

FIG. 3 is a flowchart of a communication method on an Ethernet according to an embodiment of the present invention;

FIG. 4 is a structural diagram of a communication network element according to an embodiment of the present invention; and

FIG. 5 is a structural diagram of an Ethernet network system according to an embodiment of the present invention.

### DETAILED DESCRIPTION OF THE EMBODIMENTS

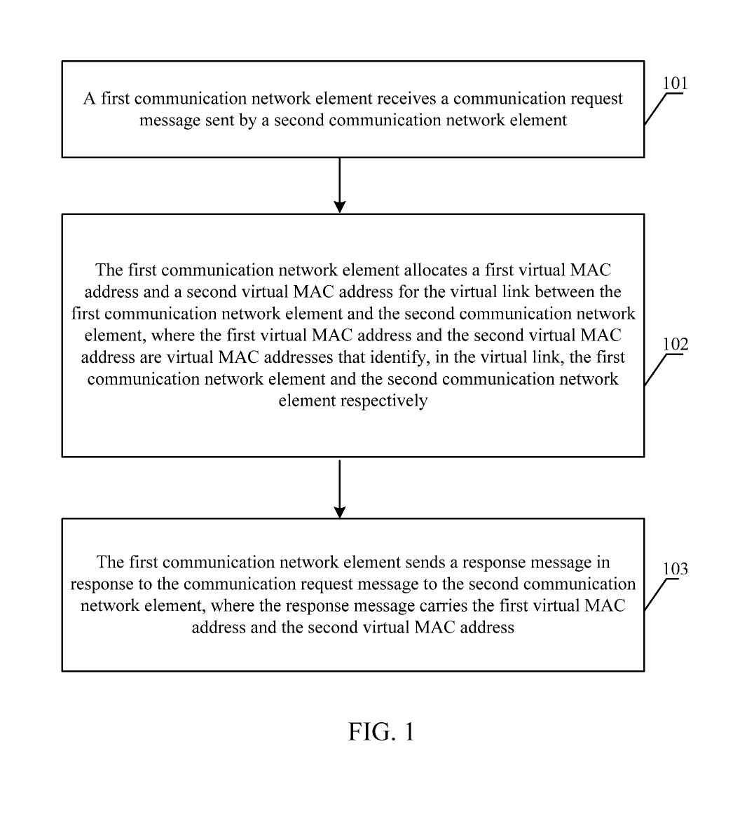

Referring to FIG. 1, an embodiment of the present invention provides a method for creating a virtual link. The method includes the following steps:

101. A first communication network element receives a communication request message sent by a second communication network element.

Where, the first communication network element and the second communication network element in this embodiment of the present invention are communication network elements on an Ethernet. The communication request message may be a unicast registration request message.

Specifically, after the second communication network element receives a unicast or multicast response message returned by the first communication network element, the unicast registration request message is sent to the first communication network element by using an Ethernet MAC address carried in the unicast or multicast response message, where the unicast or multicast response message is a response message in response to a multicast discovery request message sent by the second communication network element. Or, before this step, the first communication network element registers its Ethernet MAC address with a server. The second communication network element obtains the Ethernet MAC address of the first communication network element from the server and sends a registration request message to the first communication network element according to the Ethernet MAC address of the first communication network element, where the server may be a name server (Name Server, NS).

102. The first communication network element allocates a first virtual MAC address and a second virtual MAC address for a virtual link between the first communication network element and the second communication network element, where the first virtual MAC address is a virtual MAC address that identifies, in the virtual link, the first communication network element; and the second virtual MAC address is a virtual MAC address that identifies, in the virtual link, the second communication network element.

Specifically, the first communication network element instantiates a first virtual N port VN_Port/fibre channel over Ethernet link end point FCoE_LEP pair, allocates the first virtual MAC address bound to the first VN_Port/FCoE_LEP pair, and allocates the second virtual MAC address, where the second virtual MAC address is used to bind a second instantiated VN_Port/FCoE_LEP pair in the second communication network element. At the same time, the second virtual MAC address is recorded as a virtual MAC address of a peer communication network element (that is, the second communication network element) on a virtual link managed by the first VN_Port/FCoE_LEP pair. Subsequently, the first VN_Port/FCoE_LEP pair on the first communication network element is used to manage a data packet (this data packet may be an Ethernet frame) that is exchanged with the second communication network element; and the second VN_Port/FCoE_LEP pair on the second communication network element is used to manage a data packet (this data packet may be an Ethernet frame) that is exchanged with the first communication network element.

Where, instantiating the VN_Port/FCoE_LEP pair by a communication network element refers to instantiating two entities, VN_Port and FCoE_LEP, and creating a corresponding relationship between the two entities. If the communication network element needs to send a data packet, the VN_Port entity generates an FC frame. Then, the FCoE_LEP entity uses a virtual MAC address bound to the VN_Port/FCoE_LEP pair as a source MAC address, uses a virtual MAC address of the peer communication network element on the virtual link managed by the VN_Port/FCoE_LEP pair as a target MAC address, and encapsulates the FC frame into an Ethernet frame, and sends the Ethernet frame. If the communication network element receives the Ethernet frame from the Ethernet, the FCoE_LEP entity identifies, using the target MAC address and the source MAC address in the Ethernet frame, whether the Ethernet frame is sent to a VN_Port entity corresponding to the FCoE_LEP entity, that is, judges whether the target MAC address in the Ethernet frame is the same as the virtual MAC address bound to the VN_Port/FCoE_LEP pair, and judges whether the source MAC address in the Ethernet frame is the same as the virtual MAC address of the peer communication network element on the virtual link managed by the VN_Port/FCoE_LEP pair. If both judgments are yes, the FC frame is resolved from the Ethernet frame and transmitted to the VN_Port entity. The VN_Port entity processes the FC frame according to a fibre channel protocol.

103. The first communication network element sends a response message in response to the communication request message to the second communication network element, where the response message carries the first virtual MAC address and the second virtual MAC address.

Where, the response message in response to the communication request message may be a registration acceptance message.

In this step, the first communication network element sends the first virtual MAC address and the second virtual MAC address to the second communication network element so that the second communication network element binds the second virtual MAC address to the second VN_Port/FCoE_LEP pair and records the first virtual MAC address as the MAC address of the peer communication network element on a virtual link managed by the second VN_Port/FCoE_LEP pair after instantiating the second VN_Port/FCoE_LEP pair.

In this embodiment of the present invention, the first communication network element allocates the first virtual MAC address that identifies, in the virtual link, an address of the first communication network element, and the second virtual MAC address that identifies, in the virtual link, an address of the second communication network element, and notifies the second communication network element of the first virtual MAC address and the second virtual MAC address so that the first communication network element and the second communication network element subsequently use the virtual link identified by the first virtual MAC address and the second virtual MAC address to perform communication. At the same time, different from the prior art, a gateway device is not required to be used as an intermediary, which decreases complexity of the network and effectively avoids a problem that the gateway device becomes a bottleneck for transmitting data of high traffic when data traffic on the network is extremely high in the prior art.

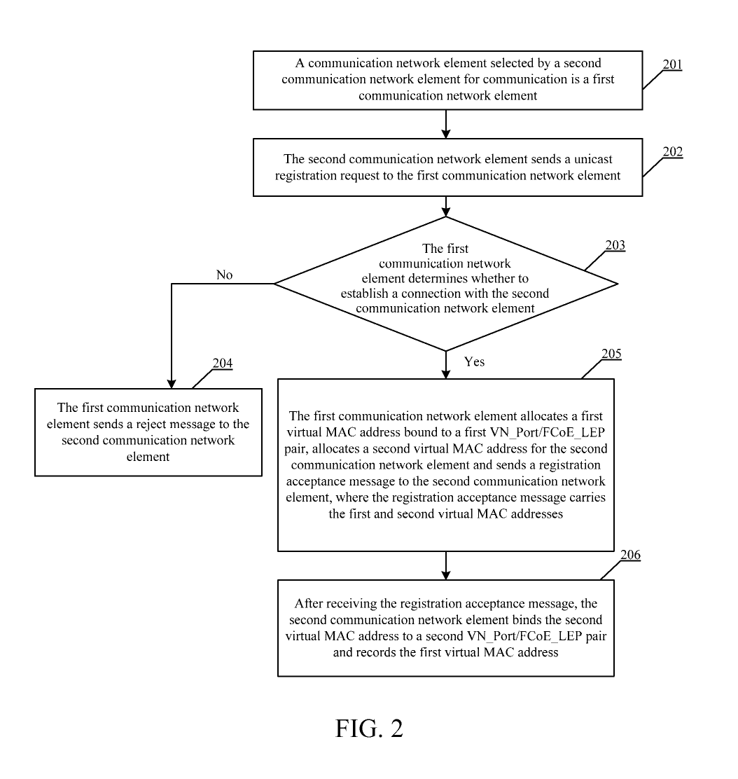

Referring to FIG. 2, another embodiment of the present invention provides a method for creating a virtual link. The method includes the following steps:

201. A second communication network element obtains information about communication network elements other than the second communication network element on an Ethernet, and selects a communication network element for communication. In this embodiment of the present invention, it is assumed that the second communication network element selects a first communication network element as the communication network element for communication.

In this step, the following two implementation manners may exist for the second communication network element to obtain the information about the communication network elements other than the second communication network element on the Ethernet:

The first implementation manner: The second communication network element sends a multicast discovery request message, where a target address of the multicast discovery request message is a multicast group address, for example, may be an All-FCF-MACs group address. The Ethernet transmits the multicast discovery request message to each of the communication network elements other than the second communication network element. After receiving the multicast discovery request message, the each of the communication network elements sends a unicast or multicast response message to the second communication network element. The unicast or multicast response message carries information about a corresponding communication network element. The information includes an Ethernet MAC address, a name of the communication network element, and so on.

The second implementation manner: When starting, each of the communication network elements on the Ethernet registers its own information with a name server (Name Server, NS). In this step, the second communication network element queries, on the NS, information about all communication network elements. The information includes an Ethernet MAC address, a name of a communication network element, and so on.

202. According to the Ethernet MAC address of the first communication network element, the second communication network element sends a unicast registration request message to the first communication network element, where a source MAC address of the unicast registration request message is an Ethernet MAC address of the second communication network element, and a target MAC address of the unicast registration request message is the Ethernet MAC address of the first communication network element.

203. After receiving the unicast registration request message, the first communication network element determines, according to a preset policy, whether to establish a connection and communicate with the second communication network element. If no, 204 is performed; if yes, 205 is performed.

Where, the preset policy may be an access control policy or another preset policy, which does not affect implementation of the present invention.

204. The first communication network element sends a reject message to the second communication network element to end the process.

205. The first communication network element instantiates the first VN_Port/FCoE_LEP pair, allocates the first virtual MAC address bound to the VN_Port/FCoE_LEP pair, allocates a virtual MAC address (assumed to be the second virtual MAC address) for the second communication network element, records the second virtual MAC address as the virtual MAC address of the peer communication network element (that is, the second communication network element) on a virtual link managed by the first VN_Port/FCoE_LEP pair, and sends a registration acceptance message to the second communication network element. A source MAC address of the registration acceptance message is the Ethernet MAC address of the first communication network element, and a target MAC address of the registration acceptance message is the Ethernet MAC address of the second communication network element. The registration acceptance message carries the first virtual MAC address and the second virtual MAC address.

206. After receiving the registration acceptance message, the second communication network element instantiates the local second VN_Port/FCoE_LEP pair, binds the second virtual MAC address to the second VN_Port/FCoE_LEP pair, and records the first virtual MAC address as the virtual MAC address of the peer communication network element (that is, the first communication network element) on a virtual link managed by the second VN_Port/FCoE_LEP pair.

In this way, a virtual link between the first communication network element and the second communication network element, that is, a virtual link between the VN_Port in the first VN_Port/FCoE_LEP and the VN_Port in the second VN_Port/FCoE_LEP, is formed. Two endpoints (the first communication network element and the second communication network element) of the virtual link are identified by the first virtual MAC address and the second virtual MAC address.

In this embodiment of the present invention, the first communication network element allocates the first virtual MAC address that identifies, in the virtual link, an address of the first communication network element and the second virtual MAC address that identifies, in the virtual link, an address of the second communication network element, and notifies the second communication network element of the first virtual MAC address and the second virtual MAC address so that the first communication network element and the second communication network element subsequently use the virtual link identified by the first virtual MAC address and the second virtual MAC address to perform communication. At the same time, different from the prior art, a gateway device is not required to be used as an intermediary, which decreases complexity of the network and effectively avoids a problem that the gateway device becomes a bottleneck for transmitting data of high traffic when data traffic on the network is extremely high in the prior art.

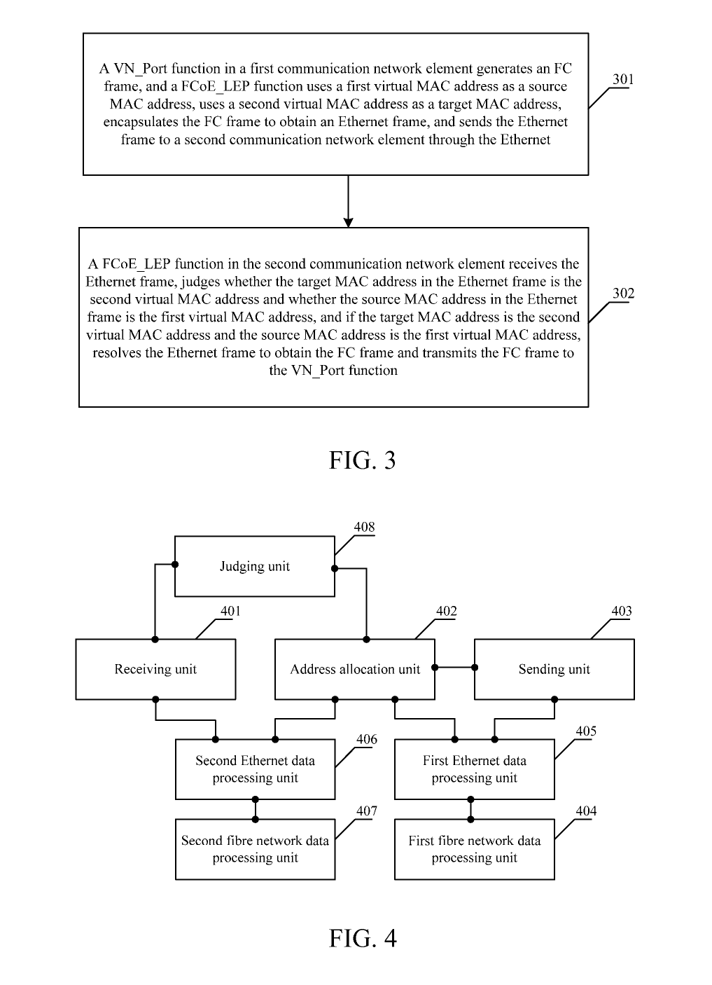

Referring to FIG. 3, the following is a method for communication between a first communication network element and a second communication network element according to an embodiment of the present invention. The method specifically includes the following steps:

301. The first communication network element generates an FC frame, uses a first virtual MAC address as a source MAC address and a second virtual MAC address as a target MAC address, encapsulates the FC frame to obtain an Ethernet frame, and sends the Ethernet frame to the second communication network element through an Ethernet.

Specifically, a VN_Port entity of a first VN_Port/FCoE_LEP pair in the first communication network element generates an FC frame. An FCoE_LEP entity uses a virtual MAC address bound to the first VN_Port/FCoE_LEP pair as the source MAC address (that is, the first virtual MAC address), uses a virtual MAC address (that is, the second virtual MAC address) of a peer communication network element on a virtual link managed by the first VN_Port/FCoE_LEP pair as the target MAC address, encapsulates the FC frame to obtain an Ethernet frame, and sends the Ethernet frame to the second communication network element through the Ethernet.

302. The second communication network element receives the Ethernet frame from the Ethernet, judges whether the target MAC address in the Ethernet frame is the second virtual MAC address and whether the source MAC address in the Ethernet frame is the first virtual MAC address, and if the target MAC address in the Ethernet frame is the second virtual MAC address and the source MAC address in the Ethernet frame is the first virtual MAC address, resolves the Ethernet frame to obtain the FC frame.

Specifically, an FCoE_LEP entity in a second VN_Port/FCoE_LEP pair in the second communication network element receives the Ethernet frame and judges whether the target MAC address in the Ethernet frame is the second virtual MAC address and whether the source MAC address in the Ethernet frame is the first virtual MAC address according to a virtual MAC address (that is, the second virtual MAC address) bound to the second VN_Port/FCoE_LEP pair and a virtual MAC address (that is, the first virtual MAC address) of a peer communication network element on a virtual link managed by the second VN_Port/FCoE_LEP pair, and if the target MAC address in the Ethernet frame is the second virtual MAC address and the source MAC address in the Ethernet frame is the first virtual MAC address, resolves the Ethernet frame to obtain the FC frame and sends the FC frame to a VN_Port entity.

Similarly, when the second communication network element serves as a transmitting end, the second communication network element may use the VN_Port entity in the second VN_Port/FCoE_LEP pair to generate an FC frame. The FCoE_LEP entity uses the virtual MAC address (that is, the second virtual MAC address) bound to the second VN_Port/FCoE_LEP pair as the source MAC address, uses the virtual MAC address (that is, the first virtual MAC address) of the peer communication network element on the virtual link managed by the second VN_Port/FCoE_LEP pair as the target MAC address, encapsulates the FC frame to obtain an Ethernet frame, and sends the Ethernet frame to the first communication network element through the Ethernet. When the first communication network element receives the Ethernet frame from the Ethernet, the FCoE_LEP entity in the first VN_Port/FCoE_LEP pair receives the Ethernet frame, judges whether the target MAC address in the Ethernet frame is the first virtual MAC address and whether the source MAC address in the Ethernet frame is the second virtual MAC address according to the virtual MAC address (that is, the first virtual MAC address) bound to the first VN_Port/FCoE_LEP pair and the virtual MAC address (that is, the second virtual MAC address) of the peer communication network element on the virtual link managed by the first VN_Port/FCoE_LEP pair, and if the target MAC address in the Ethernet frame is the first virtual MAC address and the source MAC address in the Ethernet frame is the second virtual MAC address, resolves the Ethernet frame to obtain the FC frame and sends the FC frame to the VN_Port entity.

The first communication network element and the second communication network element in the preceding embodiment are capable of using the virtual link identified by the first virtual MAC address and the second virtual MAC address to perform communication.

Referring to FIG. 4, an embodiment of the present invention provides a communication network element. The communication network element includes:

a receiving unit 401, configured to receive a communication request message sent by a peer communication network element, where the communication request message may be a unicast registration request message;

an address allocation unit 402, configured to allocate a first virtual MAC address and a second virtual MAC address for a virtual link between the communication network element and the peer communication network element after the communication request message is received, where the first virtual MAC address is a virtual MAC address that identifies, in the virtual link, the communication network element and the second virtual MAC address is a virtual MAC address that identifies, in the virtual link, the peer communication network element; and

a sending unit 403, configured to send a response message in response to the communication request message to the peer communication network element, where the response message carries the first virtual MAC address and the second virtual MAC address.

By now, the communication network element has established a virtual link with the peer communication network element. To be capable of sending an Ethernet frame to the peer communication network element, the communication network element further includes:

a first fibre network data processing unit 404 and a first Ethernet data processing unit 405, where

the first fibre network data processing unit 404 is configured to generate an FC frame;

specifically, a function of the first fibre network data processing unit 404 is equivalent to the function of the VN_Port entity in the first VN_Port/FCoE_LEP pair when a communication network element needs to send an Ethernet frame in the method embodiments; and

the first Ethernet data processing unit 405 is configured to use the first virtual MAC address as a source MAC address and the second virtual MAC address as a target MAC address, and encapsulate the FC frame to obtain an Ethernet frame; in this case, the sending unit 403 is further configured to send the Ethernet frame obtained by the first Ethernet data processing unit 405.

Where, a function of the first Ethernet data processing unit 405 is equivalent to the function of the FCoE_LEP entity in the first VN_Port/FCoE_LEP pair when a communication network element needs to send an Ethernet frame in the method embodiments.

To be capable of receiving and processing the Ethernet frame sent by the peer communication network element, the communication network element further includes: a second Ethernet data processing unit 406 and a second fibre network data processing unit 407.

Specifically, the receiving unit 401 is further configured to receive the Ethernet frame.

The second Ethernet data processing unit 406 is configured to judge whether the target MAC address in the Ethernet frame received by the receiving unit 401 is the first virtual MAC address and whether the source MAC address in the Ethernet frame is the second virtual MAC address, and if the target MAC address in the Ethernet frame is the first virtual MAC address and the source MAC address in the Ethernet frame is the second virtual MAC address, resolve the Ethernet frame to obtain the FC frame and sends the FC frame to the second fibre network data processing unit 407.

The second fibre network data processing unit 407 is configured to process the FC frame according to a fibre channel protocol.

Where, a function of the second Ethernet data processing unit 406 is equivalent to the function of the FCoE_LEP entity in the first VN_Port/FCoE_LEP pair when a communication network element receives an Ethernet frame in the method embodiments. A function of the second fibre network data processing unit 407 is equivalent to the function of the VN_Port entity in the first VN_Port/FCoE_LEP pair.

To enable each of the communication network elements other than this communication network element on the Ethernet to know the Ethernet MAC address of this communication network element, the sending unit 403 is further configured to send the Ethernet MAC address of the communication network element to a server; after the peer communication network element obtains the Ethernet MAC address of the communication network element from the server, the communication request message is sent to the communication network element according to the Ethernet MAC address.

To determine whether to establish a connection with the peer communication network element that requests communication, the communication network element further includes: a judging unit 408.

Specifically, the judging unit 408 is configured to determine whether to establish a connection with the peer communication network element according to a preset policy after the unicast registration request sent by the peer communication network element is received, where the preset policy may be an access control policy or another preset policy, which does not affect implementation of the present invention.

The address allocation unit 402 allocates the first virtual MAC address and the second virtual MAC address when a judgment result of the judging unit 408 is yes.

In this embodiment of the present invention, the communication network element allocates the first virtual MAC address that identifies itself in the virtual link, and the second virtual MAC address that identifies, in the virtual link, an address of the peer communication network element, and notifies the peer communication network element of the first virtual MAC address and the second virtual MAC address so that the two communication network elements subsequently use the virtual link identified by the first virtual MAC address and the second virtual MAC address to perform communication.

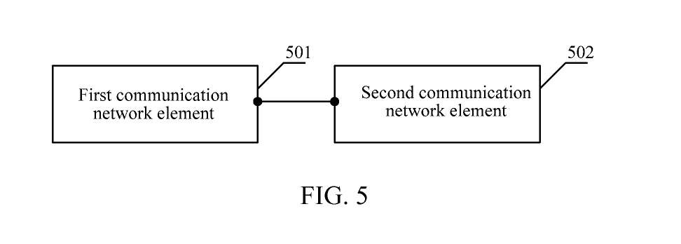

Referring to FIG. 5, an embodiment of the present invention provides a network system. The system includes: a first communication network element 501 and a second communication network element 502, where

the first communication network element 501 is configured to receive a communication request message sent by the second communication network element 502, allocates a first virtual MAC address and a second virtual MAC address to a virtual link between the first communication network element 501 and the second communication network element 502, where the first virtual MAC address is a virtual MAC address that identifies, in the virtual link, the first communication network element and the second virtual MAC address is a virtual MAC address that identifies, in the virtual link, the second communication network element; and send a response message in response to the communication request message to the second communication network element 502, where the response message carries the first virtual MAC address and the second virtual MAC address; and

the second communication network element 502 is configured to send the communication request message to the first communication network element 501 and to receive the response message in response to the communication request message, where the response message is sent by the first communication network element 501.

Where, for detailed information interaction between the first communication network element and the second communication network element, see the second embodiment and the third embodiment, and the detailed information interaction is not described here.

In this embodiment of the present invention, the first communication network element allocates the first virtual MAC address that identifies, in the virtual link, an address of the first communication network element and the second virtual MAC address that identifies, in the virtual link, an address of the second communication network element and notifies the second communication network element of the first virtual MAC address and second virtual MAC address so that the first communication network element and the second communication network element on the Ethernet are capable of using the virtual link identified by the first virtual MAC address and the second virtual MAC address to perform communication.

Those skilled in the art can understand that all or a part of the steps of the methods in the preceding embodiments may be completed by using a program instructing related hardware. The program may be stored in a computer-readable storage medium such as a Read-Only Memory, a magnetic disk, a CD-ROM, and so on.

Detailed above is a method for creating a virtual link, a communication network element, and a network system provided in embodiments of the present invention. In this document, specific examples are used to illustrate principles and implementation manners of the present invention. The description in the preceding embodiments is merely used to help understand the methods and core ideas of the present invention. At the same time, those skilled in the art can make various modifications and variations to the specific implementation manners and application scopes according to the ideas of the present invention. To sum up, content of this specification shall not be construed as a limitation on the present invention.

1. A method for creating a virtual link, comprising:
receiving, by a first communication network element, a communication request message sent by a second communication network element;
allocating, by the first communication network element, a first virtual Media Access Control (MAC) address and a second virtual MAC address for the virtual link between the first communication network element and the second communication network element, wherein the first virtual MAC address is a virtual MAC address that identifies, in the virtual link, the first communication network element and the second virtual MAC address is a virtual MAC address that identifies, in the virtual link, the second communication network element; and
sending, by the first communication network element, a response message in response to the communication request message to the second communication network element, wherein the response message carries the first virtual MAC address and the second virtual MAC address and the first communication network element and the second communication network element are located on an Ethernet.

2. The method according to claim 1, further comprising:
generating, by the first communication network element, a Fibre Channel (FC) frame, using the first virtual MAC address as a source MAC address and the second virtual MAC address as a target MAC address, encapsulating the FC frame to obtain an Ethernet frame, and sending the Ethernet frame to the second communication network element through the Ethernet.

3. The method according to claim 1, further comprising:
receiving, by the first communication network element, an Ethernet frame from the Ethernet, judging whether a target MAC address in the Ethernet frame is the first virtual MAC address and whether a source MAC address in the Ethernet frame is the second virtual MAC address, and, if the target MAC address in the Ethernet frame is the first virtual MAC address and the source MAC address in the Ethernet frame is the second virtual MAC address, resolving the Ethernet frame to obtain a Fibre Channel (FC) frame.

4. The method according to claim 1, further comprising:
registering, by the first communication network element, its own Ethernet MAC address with a server; where
the communication request message is sent to the first communication network element according to the Ethernet MAC address of the first communication network element after the second communication network element obtains the Ethernet MAC address of the first communication network element from the server.

5. The method according to claim 2, further comprising:
registering, by the first communication network element, its own Ethernet MAC address with a server; where
the communication request message is sent to the first communication network element according to the Ethernet MAC address of the first communication network element after the second communication network element obtains the Ethernet MAC address of the first communication network element from the server.

6. The method according to claim 3, further comprising:
registering, by the first communication network element, its own Ethernet MAC address with a server; where
the communication request message is sent to the first communication network element according to the Ethernet MAC address of the first communication network element after the second communication network element obtains the Ethernet MAC address of the first communication network element from the server.

7. The method according to claim 1, further comprising:
sending, by the first communication network element, a unicast or multicast response message to the second communication network element;
wherein the communication request message is sent by the second communication network element according to an Ethernet MAC address carried in the unicast or multicast response message.

8. The method according to claim 2, further comprising:
sending, by the first communication network element, a unicast or multicast response message to the second communication network element;
wherein the communication request message is sent by the second communication network element according to an Ethernet MAC address carried in the unicast or multicast response message.

9. The method according to claim 3, further comprising:
sending, by the first communication network element, a unicast or multicast response message to the second communication network element;
wherein the communication request message is sent by the second communication network element according to an Ethernet MAC address carried in the unicast or multicast response message.

10. The method according to claim 1, further comprising:
determining, by the first communication network element, whether to establish a connection with the second communication network element according to a preset policy, and triggering execution of the step of allocating, by the first communication network element, the first virtual MAC address and the second virtual MAC address for the virtual link between the first communication network element and the second communication network element, when the first communication network element determines to establish the connection with the second communication network element according to the preset policy.

11. A communication network element, which is located on an Ethernet, comprising:
a receiving unit, configured to receive a communication request message sent by a peer communication network element;
an address allocation unit, configured to allocate a first virtual Media Access Control (MAC) address and a second virtual MAC address for a virtual link between the communication network element and the peer communication network element after the communication request message is received, wherein the first virtual MAC address is a virtual MAC address that identifies, in the virtual link, the communication network element and the second virtual MAC address is a virtual MAC address that identifies, in the virtual link, the peer communication network element; and
a sending unit, configured to send a response message in response to the communication request message to the peer communication network element, wherein the response message carries the first virtual MAC address and the second virtual MAC address.

12. The communication network element according to claim 11, further comprising:
a first fibre network data processing unit, configured to generate a Fibre Channel (FC) frame;
a first Ethernet data processing unit, configured to use the first virtual MAC address as a source MAC address and the second virtual MAC address as a target MAC address, and encapsulate the FC frame to obtain an Ethernet frame; and
the sending unit is further configured to send the Ethernet frame obtained by the first Ethernet data processing unit.

13. The communication network element according to claim 11, wherein:
the receiving unit is further configured to receive an Ethernet frame; and
the communication network element further comprises: a second Ethernet data processing unit and a second fibre network data processing unit, wherein
the second Ethernet data processing unit is configured to judge whether a target MAC address in the Ethernet frame is the first virtual MAC address and whether a source MAC address in the Ethernet frame is the second virtual MAC address, and if the target MAC address in the Ethernet frame is the first virtual MAC address and the source MAC address in the Ethernet frame is the second virtual MAC address, resolve the Ethernet frame to obtain a Fibre Channel (FC) frame and sends the FC frame to the second fibre network data processing unit; and
the second fibre network data processing unit is configured to process the FC frame according to a fibre channel protocol.

14. The communication network element according to claim 11, wherein:
the sending unit is further configured to send an Ethernet MAC address of the communication network element to a server; and
the communication request message is sent to the communication network element according to the Ethernet MAC address of the communication network element after the peer communication network element obtains the Ethernet MAC address of the communication network element from the server.

15. The communication network element according to claim 11, further comprising:
a judging unit, configured to determine whether to establish a connection with the peer communication network element according to a preset policy after the communication request message sent by the peer communication network element is received; and
the address allocation unit is configured to allocate the first virtual MAC address and the second virtual MAC address for the virtual link between the communication network element and the peer communication network element, after the communication request message is received and when a judgment result of the judging unit is yes.

16. An Ethernet network system, comprising:
a first communication network element, configured to receive a communication request message sent by a second communication network element; to allocate a first virtual MAC address and a second virtual MAC address for a virtual link between the first communication network element and a second communication network element, wherein the first virtual MAC address is a virtual MAC address in the virtual link identifying the first communication network element, the second virtual MAC address is a virtual MAC address in the virtual link identifying the second communication network element; and to send a response message in response to the communication request message to the second communication network element, and the response message carries the first virtual MAC address and the second virtual MAC address; and
the second communication network element, configured to send the communication request message to the first communication network element and receive the response message in response to the communication request message from the first communication network element.
